(19) United States
(12) Patent Application Publication
(10) Pub. No.: US 2015/0355877 A1
(43) Pub. Date: Dec. 10, 2015

(54) KEY INPUT DEVICE, KEY INPUT RECOGNITION DEVICE, AND KEY INPUT SYSTEM USING SAME

(71) Applicant: Nam Kyu KIM, Seoul (KR)

(72) Inventor: Nam Kyu KIM, Seoul (KR)

(21) Appl. No.: 14/759,851

(22) PCT Filed: Feb. 6, 2014
(86) PCT No.: PCT/KR2014/004892

§ 371 Date: Jul. 8, 2015

(30) Foreign Application Priority Data
Jun. 21, 2013 (KR) 10-2013-0071824

(51) Int. Cl. G06F 3/16; G06F 3/02

(52) U.S. Cl. CPC G06F 3/16; G06F 3/0202

(57) ABSTRACT

The present invention relates to a key input device that allows a key input recognition device to recognize key making input through the key input device even without a specific power, a key input recognition device, and a key input system using them. A plurality of key generating different sounds in physical way is provided, so it is possible to discriminately recognized in accordance with sounds generated in input even without a power, and accordingly, free key input is possible without a communication or electric limit.

### CROSS-REFERENCE TO RELATED APPLICATION

This application claims the benefit of Korean Application No. 10-2013-0071824 filed on Jun. 21, 2013 with the Korean Intellectual Property Office, the disclosure of which is incorporated herein by reference.

### BACKGROUND OF THE INVENTION

1. Field of the Invention

The present invention: relates to a key input device, a key input recognition device, and a key input system including the same, particularly, to a key input device that allows a key input recognition device to recognize keys inputted through the key input device even without a specific power, a key input recognition device, and a key input system including the key input device and the key input recognition device.

2. Description of the Related Art

Various interactive ways have been proposed between human and electronic devices with development in the information communication technology.

In particular, mobile devices are equipped with various input sensors such as a touch screen, a sound sensor, and an acceleration sensor and provide various ways of input using them, but it is still inconvenient in comparison to the input type using a specific keyboard, when inputting long sentences.

Meanwhile, recent mobile devices have been improved in performance with the great convenience in portability maintained, so it is possible to edit common documents, manage blogs, and program through the mobile devices and accordingly, those mobile devices are more increasingly used for work instead of large notebooks. Accordingly, keyboards that can be operated in combination with those mobile devices are recently used.

FIG. I illustrates common pad type terminal 10 and wireless keyboard 20. In general, the wireless keyboard 20 wireless connects with the pad type terminal 20 and transmits input by a user to the terminal 10.

Obviously, the wireless keyboard 20 is also widely used for a common PC, a TV having the function of a PC, a set-top box, and industrial equipment, in addition to the pad type terminal 10.

The wireless keyboard 20, however, cannot be supplied with power from the terminal 10 and uses an independent power, so when it is fully discharged, it cannot be used, even if necessary, in many cases. In particular, the number of wireless keyboards that cannot use common batteries for reducing the thickness and simplifying has been increased, and when a charging environment is not provided, it is difficult to charge those wireless keyboards and use them for a long time, so reliability is deteriorated.

Therefore, there is a request for a new key input type allowing for efficient key input by enabling various terminals to easily recognize input from external key input devices even without a power.

### PRIOR ART DOCUMENT

### Patent Document

(Patent Document 1) Korean Patent No. 10-1251730

(Patent Document 2) Korean Patent No. 10-1068869

### SUMMARY OF THE INVENTION

An object of the present invention is to provide a key input device that can discriminate and recognize keys on the basis of sounds generated in inputting, even if there is no power, using a plurality of keys capable of generate different sounds in a physical way.

Another object of the present invention is to enable processing user input through a separate key input device even without a specific power by providing a key input recognition device that discriminately recognizes keys on the basis of sounds corresponding to unique sounds generated in key input and then processes input of corresponding keys.

Another object of the present invention is to enable input at the same level as a key input device actually using a power by making it possible to discriminately process repeated input and input through several keys on the basis of pressing-down time, by generating different sounds when keys are pressed down and released so that pressing-down and releasing are discriminately recognized.

Another object of the present invention is to enable adjusting a sound key input mode or providing additional functions by combining the function of a terminal capable of processing input by a user with keys generating sounds.

Another object of the present invention is to allow a user to effectively find out input states by enabling the user to discriminate key input with his/her ears through unique sounds generated in key input and to provide new enjoyment through various sounds generated in key input.

According to an aspect of the present invention, a key input device includes: sound keys that generate different unique sounds when being pressed; and a body where the sound keys are arranged, in which the sound keys include a sound generator that generates discriminative unique sounds, respectively, in accordance with a physical change when being pressed and returned.

Sound generators of the sound keys each may generate different unique sounds when one keys are pressed and returned.

The sound keys each may further include a signal generator in which electrodes ere brought in contact by key input, and the key input device may further include an input signal generator that creates a standard key input signal and transmits the signal through wire/wireless communication in accordance with operation of the signal generators of the sound keys.

The unique sound may be used as a factor by which at least one of a natural frequency, a unique pattern, and a unique sound feature is discriminated.

The sound generator may be an elastic unit for pressing and returning the key or an elastic member inducting electrode contact when the key is pressed and returned.

The sound generators may be different in physical shape for each key.

The sound keys or the body may have an opening for transmitting a sound to a terminal corresponding to the key input device.

According to another aspect of the present invention, a key input recognition device includes: a microphone that receives a sound; a sound input processor that discriminates of predetermined unique sounds of sound keys from sounds received by the microphone, recognizes the kinds of the keys, and determines that input has been made through the keys; and a controller that performs a process of processing the key input in accordance with the determination result by the sound input processor.

The sound input processor may determine a key input state, a continuous input state according to an input-continued time, and a complex key input state according to simultaneous pressing or a plurality of keys, on the basis of unique sounds generated when the sound keys are pressed and returned.

Herein, the sound input processor may recognize a predetermined unique sound according to pressing of a sound key, and determine input as a result of key combination according to complex key input when the sound input processor determines that another sound key has been pressed before a unique sound according to returning of the key is recognized.

The sound input processor may process key input at a high speed on the basis of only the unique sound according to pressing of a sound key, in accordance with a mode or the kind of a key.

The key input recognition device may further include a user interface receiving selection information by a user in cooperation with the controller, in which the sound input processor may change a determination way according to recognition of a unique sound of a sound key in accordance with selection information by a user provided through the user interface.

According to another aspect of the present invention, a key input system includes: a key input device that includes sound keys generating different unique sounds when keys are pressed; and a key input recognition device that receives sounds generated by the sound keys through a sound sensor when input is made through the key input device, discriminately recognizes the unique sounds of the sound keys from received sounds, and determines that input has been made through the keys and processes corresponding key input.

According to a key input device that allows a key input recognition device to recognize key making input through the key input device, a key input recognition device, and a key input system using them of the present invention, a plurality of key generating different sounds in physical way is provided, so it is possible to discriminately recognized in accordance with sounds generated in input even without a power, an accordingly, free key input is possible without a communication or electric limit.

According to a key input device, a key input recognition device, and a key input system using them of the present invention, pressing and releasing are recognized respectively by generating different sounds when keys are pressed and released, so it is possible to process complex key input for repeated input according to pressing time and further pressing another key between key input. Accordingly, it is possible to achieve input at the equivalent level to a key input unit using an actual power.

Another object of the present invention is to enable adjusting a sound key input mode or providing additional functions by combining the function of a terminal capable of processing input by a user with keys generating sounds.

According to a key input device, a key input recognition device, and a key input system using them of the present invention, it is possible to recognize unique sounds according to key input with ears even without a specific power, so a user can effectively recognize the input state. Further, it is possible to provide new enjoyment through various sounds according to key input.

### BRIEF DESCRIPTION OF THE DRAWINGS

FIG. 1 is a diagram illustrating an example of use of a terminal and a wireless key input device of the related art.

FIG. 2 is a diagram illustrating the configuration of a key input system according to an embodiment of the present invention.

FIGS. 3A and 3B are cross-sectional views illustrating a sound key according to an embodiment of the present invention.

FIG. 4 is a conceptual diagram illustrating a key input way according to an embodiment of the present invention.

FIGS. 5A and 5B are diagrams illustrating a key input device according to an embodiment of the present invention.

FIG. 6 is a flowchart illustrating operation of a key input recognition device according to an embodiment of the present invention.

FIG. 7 is a flowchart illustrating a process of processing input in a key input recognition device according to an embodiment of the present invention.

FIG. 8 is a conceptual diagram illustrating operation modes of a key input recognition device according to an embodiment of the present invention.

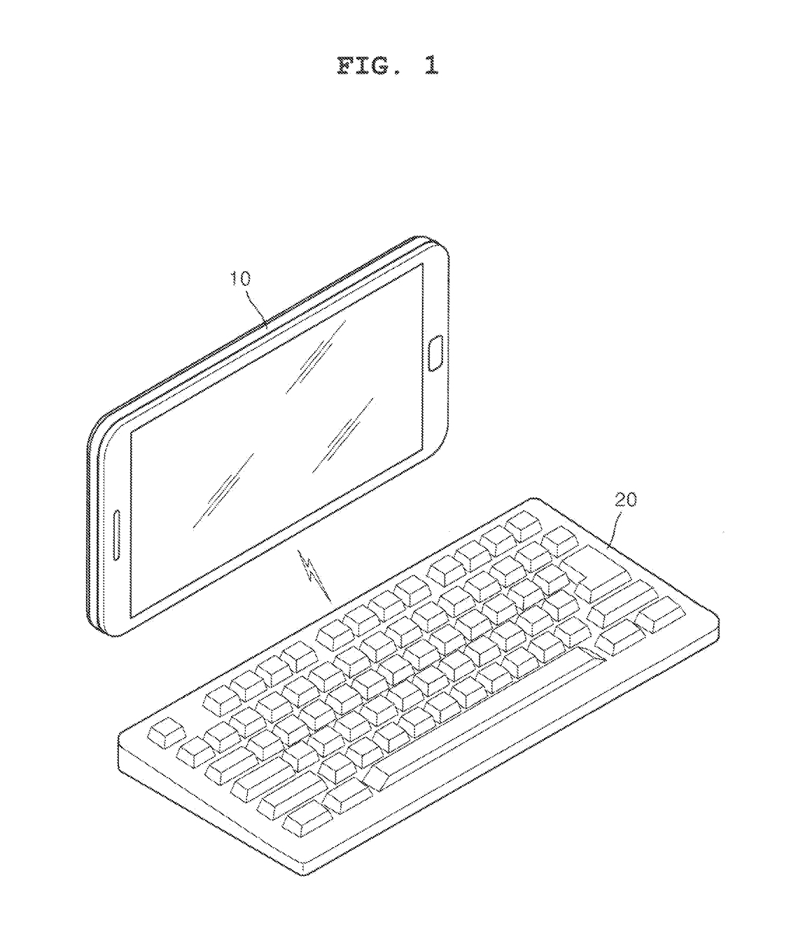

### DETAILED DESCRIPTION OP THE PREFERRED EMBODIMENTS

The present invention will be described in detail with reference to the accompanying drawings and embodiments.

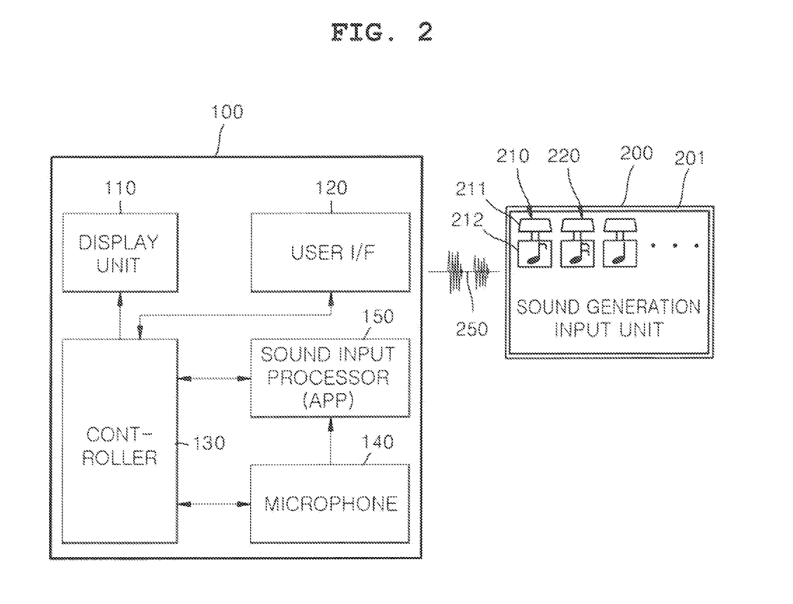

FIG. 2 is a diagram illustrating the configuration of a key input system according to an embodiment of the present invention. As illustrated in FIG. 2, a key input system according to an embodiment of the present invention includes: a key input device 200 with sound keys 210 and 220 that generate different unique sounds when being pressed and a key input recognition device 100 that receives unique sounds 250 generated by the sound keys 210 and 220 through a sound sensor, when input is made through the key input device 200, discriminately recognizes the unique sounds of the sound keys from the received sounds, determines that input has been made through corresponding keys, and processes corresponding key input.

Herein, the key input device 200 includes, as illustrated in FIG, 2, the sound keys 210 and 220 that generate different unique sounds when being pressed and a body 201 on which the sound keys 210 and 220 are arranged. The sound key 210 includes a key 211 that is pressed and released by a user who makes input and a sound generator 212 that physically generates a unique sound in response to physical movement of the key 211.

The sound generator 212 generates a unique sound having a natural frequency and a unique pattern, of which at least one is an identifier, when the key 211 is pressed or released, and to this end, various physical structures can be applied.

That is, a sound with a natural frequency may be generated, a sound with a specific feature may be generated, or a sound with a specific pattern may be generated with physical movement of the key 211. For example, a vibration member vibrates with movement of the key 211 may be used and may have different thicknesses, sizes, or shapes, depending on keys. Further, a specific pattern may be given to the vibration member so that a sound with a specific waveform is generated in accordance with the pattern, and a plurality of vibration members may be provided so that a plurality of sounds are combined in accordance with movement of a key.

The sound key 210 may be an exclusive sound generator for generating a sound in response to key input, but may further include the function of an electric switch that is switched in response to key input. If the sound key 210 has the function of an electric switch and generates a unique sound in response to key input, when a power is provided, the key input device 200 may be used as a key input device using a power each as a keyboard and a keypad of the related art when a power is provided, but when a power is not provided, it may be used as a key input device using sounds.

In this case, the sound key 210 may further include a signal generator (not illustrated) in which electrodes are brought in contact with each other in response to key input and the key input device 200 may further include an input signal generator (not illustrated) generating a standard key input signal in response to operation of the signal generator and transmitting it through wire/wireless communication.

Common key input device of the related art using a power include one or more elastic members for pressing and returning keys and one of the elastic members may be metallic member inducing selective electrode contact or a synthetic resin member including a metallic member, but the sound keys according to the present invention can use an elastic member for returning, a metallic member for electric contact, or a plastic member as a part tor generating a unique sound.

Keys generally used at present have various structures, and for example, keys for inputting characters or numbers are classified usually into a membrane type, a pentagraph type, and mechanical type. Other than these types, there are various switch structures, but the sound keys according to an embodiment of the present invention can be effectively applied to these various existing structures of keys.

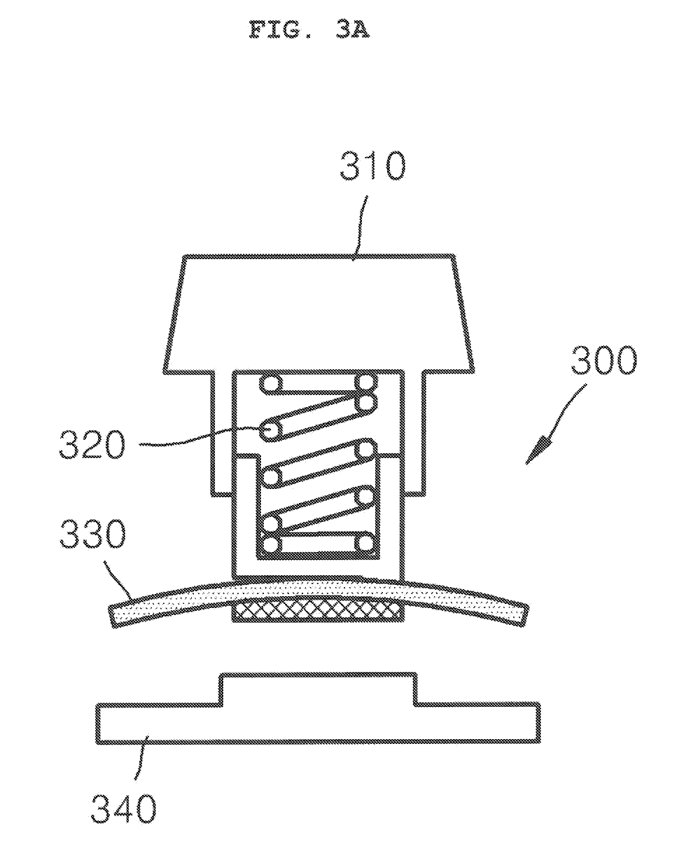

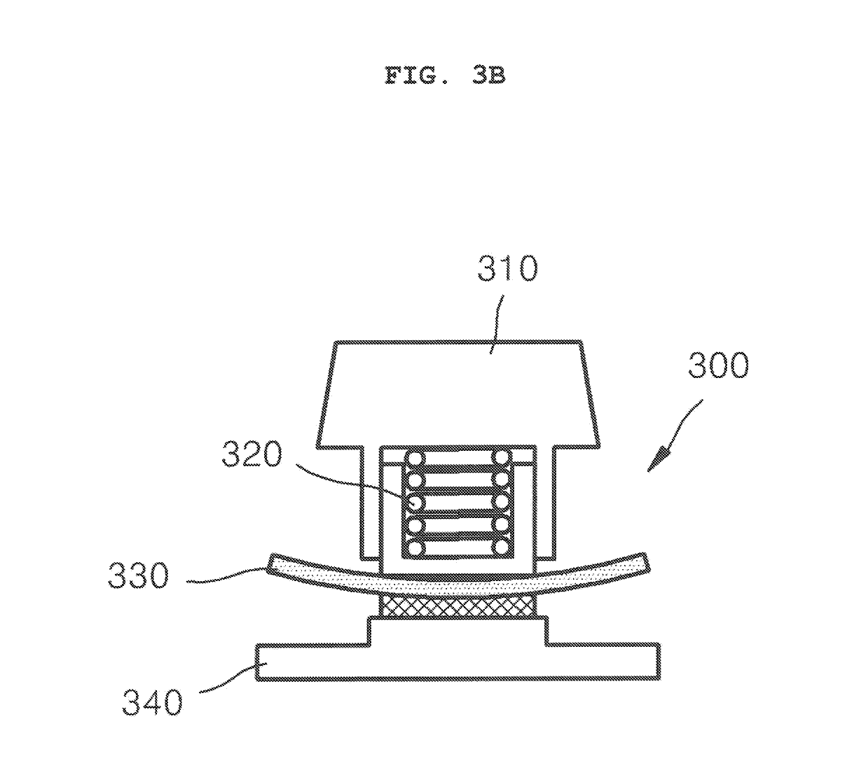

FIGS. 3A and 3B illustrate a sound key 300 having a mechanical key structure known in the art, in which an elastic member tor electric contact of mechanical keys generally used in the art as a vibration member for generating a unique sound, thereby using the elastic member as a sound generator of a sound key.

The sound key 300 illustrated in FIGS. 3A and 3B has a structure similar to those of mechanical keys known in the art in terms of the actual structure and includes: a key 310 that transmits a physical force for key input by moving up and down in response to input by a user; an elastic unit 320 that is used for discriminate whether there is input through the key 310 (when a predetermined force is applied, actual input is made and a user can sense it) and returns the pressed key; an elastic member 330 that, when a predetermined level or more force is applied to the elastic unit 320, receives and bends with the top position changed, and that, when the force applied to the elastic unit 320 decreases to a predetermined level or less, returns from the bending position, and that generates a unique sound when bending or returning; and an electrode 340 that comes in contact with the elastic member 330 when the elastic member 330 bends. Obviously, other than the structure illustrated in FIGS. 3A and 38, there is a need for an additional structure for fixing physical shape and position, but it is well known in the art and not described herein.

The elastic member 330 may be a metallic member or a plastic member added with a metallic member (conductive member). When the key 310 is pressed, it can generate a first unique sound, and when the key 310 is returned, it can generate a second sound.

Obviously, the elastic unit 320 may generate a unique sound and different unique sounds may be generated when the key is pressed and released by a combination of the elastic unit 320 and the elastic member 330.

Meanwhile, an elastic member applied not to the mechanical key illustrated in FIGS. 3A and 3B, but other types of keys may be used as a vibration member and a specific key structure can be achieved even without using the structure of the keys in existing input device.

Referring to FIG. 2 again, the key input recognition device 100, which receives a unique sound 250 generated by the sound keys 210 and 220 of the key input device 200 described above, recognizes the key corresponding to the unique sound, and processes input, includes, as illustrated in FIG. 2, a microphone 140 that receives a sound, a sound input processor 150 that removes noise from the sound received by the microphone 140, examines predetermined unique sounds of sound keys, recognizes the type of the corresponding key, and determines that input has been made through the key, and a controller 130 that performs a process of processing the key input in accordance with the determination result by the sound input processor 150.

The key input device 100 may be achieved by installing the sound input processor 150 in a common user terminal like an application. When the key input device 100 includes a user terminal, it may basically include a display unit 110 and a user interface 120 such as a terminal button, a touch screen, an acceleration sensor, an optical sensor, and a camera for directly receiving user input and a user interface 120. Obviously, though not illustrated, a plurality of communication units may also be included.

When the key input recognition device 100 includes a user terminal and the key input device 200 can operate as a wire/wireless key input device using a power, the key input recognition device 100 can receive a standard key input signal through a communication (not illustrated) and the controller 130 can process the input through a corresponding key.

Obviously, the key input recognition device 100, as an independent part, may include only the microphone 140, the sound input processor 150, and the controller 130, as described above, but if necessary, it may further include the user interface 120 for predetermined cooperative operation.

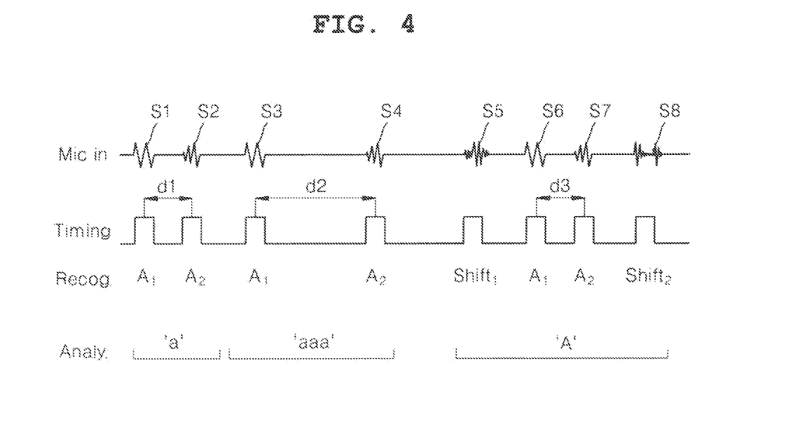

A process of recognizing key input through a unique sound 250 generated by the sound key 210 and 220 in the key input recognition device 100 is described with reference to the example illustrated in FIG. 4. In the example, the sound keys generate different unique sounds when being pressed and released.

FIG. 4 illustrates three situations that are processed when a user taps a first sound key 210, when a user presses the first sound key 210 for three seconds and releases it, and when a user taps the first sound key 210 with a second sound key 220 pressed and then releases the second sound key 220, on the assumption than the first key 210 is an ‘a’ key and the second sound key 220 is a ‘shift’ key in the key input recognition device 100.

The microphone 140 converts a received sound into an electrical signal and sends it to the sound input processor 150, and as illustrated in FIG. 4, eight disconnected signals S1 to S8 are provided.

The sound input processor 150, which respectively discriminates signals from the microphone 140 and checks whether there has been input through keys corresponding to unique sound information carrying by the signals, discriminately recognizes unique sounds A1 and Shift1 when keys are pressed and unique sounds A2 and Shift 2 when the keys are returned, respectively, and measures delays d1, d2, and d3 between sound signals generated when the same key is pressed and released. In this case, as for delay times d1 and d3 within a predetermined reference, it is determined that the key has been pressed one time, and as for the delay time d2 over the predetermined reference, it is determined input has been made at several times in accordance with a predetermined unit of delay count after the a reference time passes. On the other hand, as for exclusive keys (shift, Ctrl, Alt, and the like) not for actually inputting characters, but for combination of keys, the only pressed-down state is important, so delays may not be specifically measured, as illustrated in FIG. 4.

In accordance with the determination reference, the sound input processor 150 recognizes key input as ‘a’, ‘aaa’, and ‘A’ by analyzing input of the microphone 140, as illustrated in FIG. 4, and transmits the information to the controller 130 so that input made through the corresponding keys is processed.

It is possible to discriminate individual input, continuous input, and complex (combined) input by discriminating unique sounds generated when sound keys are pressed and returned, as described above.

In particular, since various algorisms for separating individual signals from a complex signal has recently been developed, even if some sound signals overlap, they can be discriminately recognized. Further, there is generally a predetermined delay between key inputs, so a unique sound is a disconnected sound or a predetermined earlier period of a unique sound is used for discrimination, key input at a satisfactory level can be achieved.

Meanwhile, the key input device uses sounds that are diffused in the art, so it is preferable to concentrate sounds to the microphone supposed to receive the sounds. To this end, it is preferable to apply an amplifying structure for physically amplifying sounds on the key of a sound key or a body having sound keys or apply a transmission structure for transmitting sounds to a desired place, and it is preferable to form an opening in a corresponding direction or at a corresponding portion so that a part generating a sound is close to a key input recognition device.

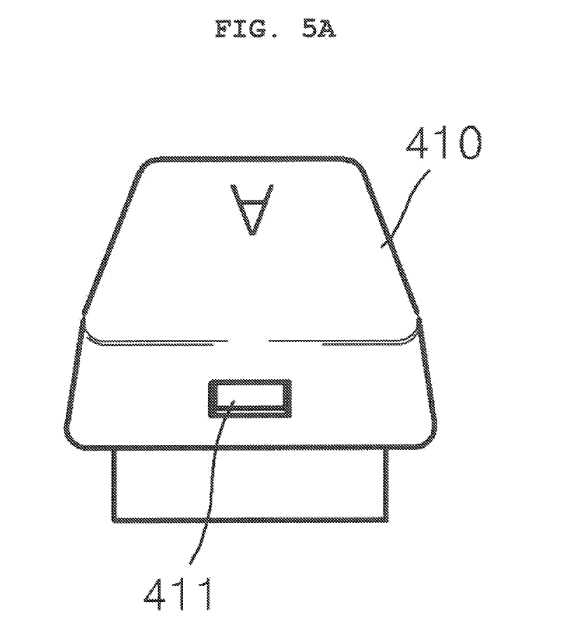

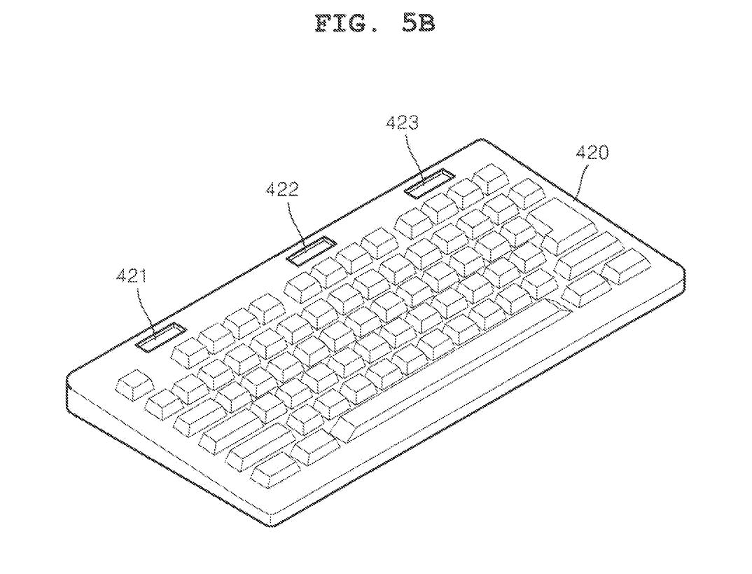

FIG. 5A illustrates an example of an opening 411 formed at a portion of a key 410 of a sound key to concentrate a sound generated therein to a key input recognition device and FIG. 5B illustrates an example of openings 421 and 423 formed concentrating sounds to a portion of a key input device body 420 of a key input device in accordance with the arrangement or a key input recognition device and the direction of a microphone. The openings 421 and 423 may be selectively opened.

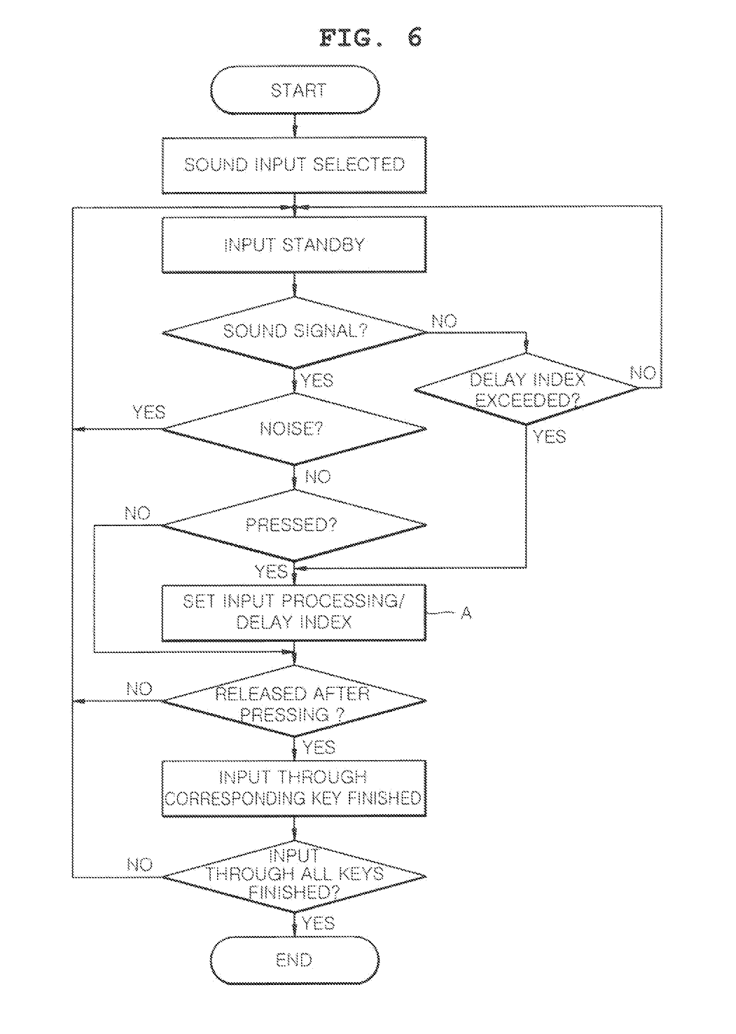

Hereinafter, the process of receiving a sound from a sound key and processing key input by means of the sound input processor illustrated in FIG. 2 is described in more detail with reference to FIGS. 6 to 8.

The flowcharts illustrating a process of processing input are provided for understanding an embodiment of the present invention, the actual processing orders may depend on the kind and the processing way of hardware and software, and some components may be removed or additional components may be included, so the flowcharts should be considered as references for understanding the embodiment.

FIG. 6 is a flowchart illustrating the entire operation of a key input recognition device according to an embodiment of the present invention, in which, first, a sound is set as an input means for operating a sound input processor. As the sound input processor operates, a sound signal is transmitted from a sound sensor such as a microphone.

When a sound signal at a predetermined level or more is received in an input standby state, the sound input processor filters noise, checks whether there is a unique sound in the sound with noise filtered, and determines whether it is a unique sound generated by pressing a key.

When it is a unique sound generated by pressing a key, the input made through the key is transmitted to a controller and processed. Further, a delay index corresponding the pressing time of the key is set to check continuous input. Though not illustrated, when the key is a key that is meaningless in continuous input, the process of setting a delay index may be omitted and only the information about the pressed state of the key is used. The setting of a delay index may be to initialize a delay index for a key counted at predetermined time and then determine a reference count for checking excessive determination.

When the recognized unique sound is a unique sound generated by releasing (returning) the key, input through the key is finished. When a unique sound by returning is recognized without signal by pressing recognized, the information processed as one-time pressing of the key or may be neglected because there is no processing process, as illustrated in the figure.

If input through all the keys is finished, basic input recognition is finished, and this process may be repeated until the sound input mode is finished.

If input through all the keys is not finished, that is, there is a pressed key, generation of sound signals is checked again in the input standby state. When there is a key of which a delay index based on pressing exceeds a predetermined reference level even without a sound signal generated, it means that the key has been continuously input, so input through the key is processed and the delay index is reset. This process is repeated until a returning signal of the key is recognized.

On the other hand, when there is no delay index exceeding the reference level with keys pressed, it may mean that a plurality of keys is pressed to combine input through the keys for complex key input, so in this case, it keeps waiting next input.

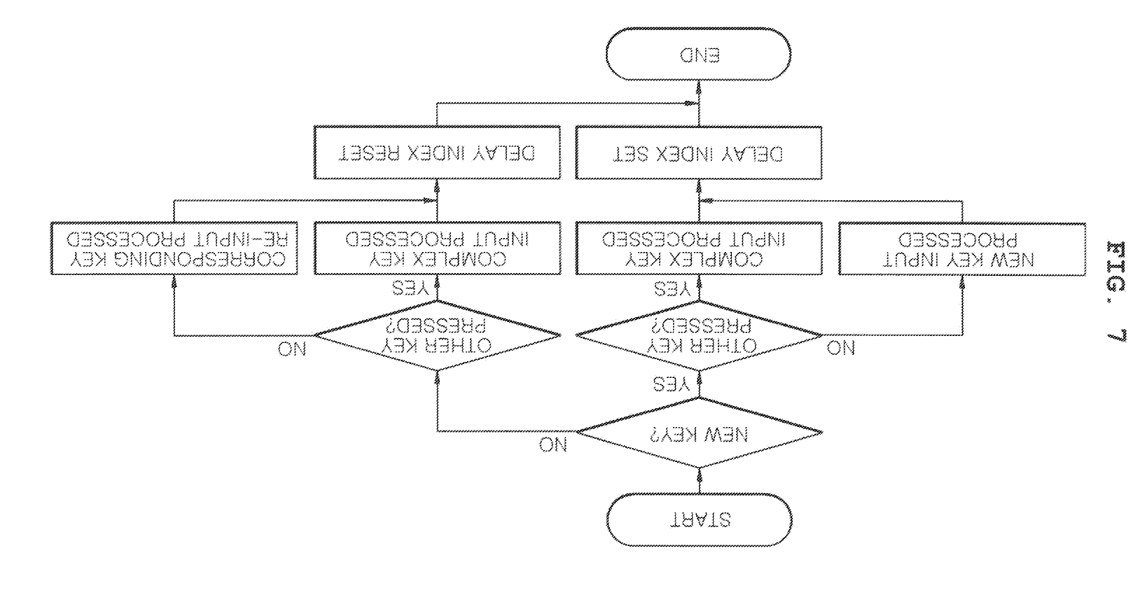

FIG. 7 illustrates in detail the step A of processing input and a delay index when a key is pressed or a delay index exceeds the reference level in the process illustrated in FIG. 6, in which it is exemplified that a process continuous key input and complex key input.

As illustrated in FIG. 7, it is determined whether a key that is processed input or of which the delay index exceeds the reference level has been pressed first time or continuously pressed, by checking whether the key is a new key, in order to process input or a delay index.

If the key is a new key, whether there is another pressed key is checked, and if there is no pressed key, new input through the key is processed and a delay index is set for an initial reference time for finding out whether it is continuous key input. For example, the initial reference time may be one second.

If a key is a new key and there is another pressed key, it is considered as complex key input and a corresponding process is performed, but if another pressed key is a key for combination, a key input state including effect by the key for combination is outputted as a result. In this case, continuous key input is possible even in the combination state, and a delay index for an initial reference time is set for the new key. Herein, the effect of complex key input can show the operation type of a common key input device using a power.

Meanwhile, when the delay index of a pressed key exceeds the reference level and a process of processing input is started, that is, when it is not a new key, whether there is another pressed key is checked.

If there is no other pressed key, only the key has been continuously input, so addition key input is processed and the delay index is reset shorter than the initial reference time. For example, the reference time after determining continuous input may be set to of 0.3 seconds and can be adjusted when the process is repeated. If there is another pressed key, it is continuous key input in a complex key input state, so in this case, a key input state where an effect of combination of complex keys is outputted as a result and the delay index is reset shorter than the initial reference title.

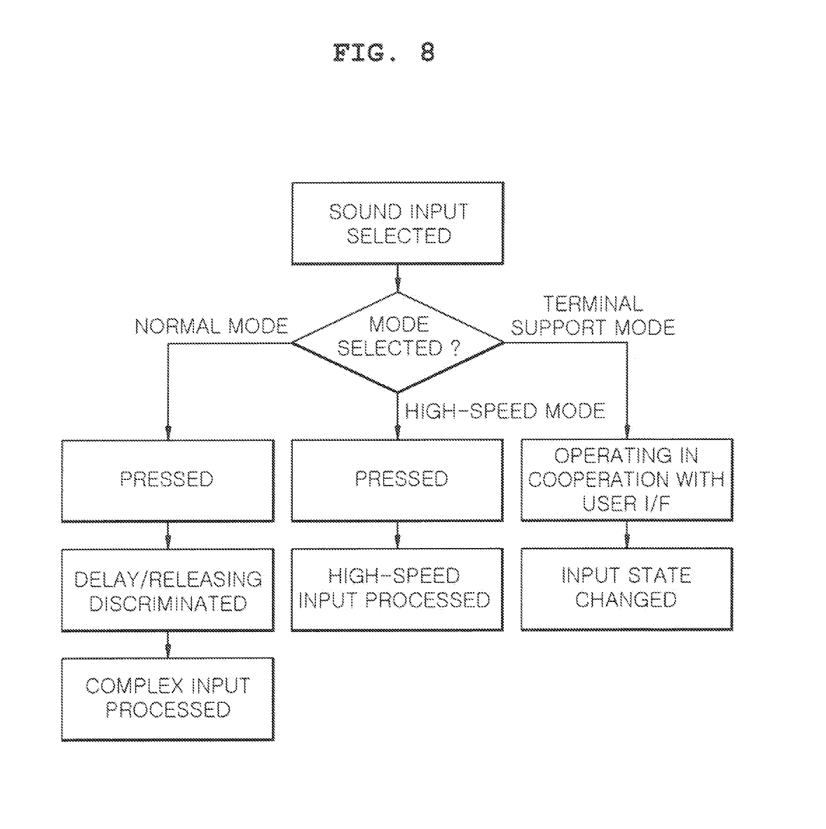

FIG. 8 is a conceptual diagram illustrating operation modes of a key input recognition device according to an embodiment of the present invention, in which a plurality of exemplary modes, which can be additionally selected when a sound input mode is selected first through setting-up of the key input recognition device, is shown.

A normal mode is a case in which input through a key is processed on the basis of a unique sound generated when a sound key is pressed, and as described with reference to FIGS. 6 and 7, delay input is checked by discriminately recognizing a unique sound when the sound key is returned, and accordingly, complex input can be processed.

A high-speed mode is a case in which input through a key is processed on the basis of a unique sound generated when a sound key is pressed, but a unique sound when the sound key is returned is neglected so that high-speed input processing is possible.

Obviously, though not illustrated in the figure, a hybrid mode, combination of the normal mode and the high-speed mode, may be achieved, in which as for combination keys (Shift, Ctrl, Alt, and the like) or keys (space bar, ESC, DEL, Enter, and the like), which are frequently continuously input, are pressed or returned, the unique sounds generated in pressing and returning are discriminately recognized, but as for other keys, only the unique sound generated in pressing is discriminately recognized. Alternatively, the sound, generating structure of a key input device may be configured initially for the hybrid mode.

Meanwhile, a terminal support mode may be further provided, which changes a sound recognition and determination way provided by a key input device, when a user interface for receiving input by a user is further provided in the key input recognition device, by setting or operating by a user through the user interface.

For example, when an acceleration sensor or a shock sensor is used as the user interface, a user can change a mode into an input mode by patting a user input recognition device while making input through the key input device, set a state change (Korean/English) requiring combination of a plurality of keys, and adjust recognition precision (recognition speed).

As another example, when a touch screen is used for the user interface, an input mode or a state is changed by touching a specific area or a function of supplementing instable input due to a recognition error can be performed.

As a result, the key input device according to an embodiment of the present invention described above is independently used so that free and various types of key input are achieved only by sounds. Further, it is possible to allow for key input even without a power by combining it with a key input device using a power in the related art, so practicality of the key input device can be maximized. Although a keyboard was exemplified as the key input device to effectively describe the present invention, the key input device of the present invention can generally include, other than a keyboard, various input devices such as various switches, a keypad, and a control board.

Further, the key input recognition device according to an embodiment of the present invention can be individually used and can convert sound information by a key input device into a key input signal. Further, when it is applied to a user terminal, it is possible to process user input on the basis of a sound signal from the key input device, using a sound sensor or a controller in the user terminal, only by installing an application, so the key input device can be achieved without a burden of cost.

Embodiments of the present invention were described above with reference to the drawings. However, the present invention is not limited to the embodiments and may be modified in various ways by those skilled in the art without departing from the scope of the present invention described in claims.

What is claimed is:

1. A key input device comprising:
sound keys chat respectively generate different unique sounds when keys are pressed; and
a body where the sound keys are arranged,
wherein the sound keys include a sound generator that generates discriminative unique sounds respectively in accordance with a physical change when being pressed and returned.

2. The key input device of claim 1, wherein sound generators of the sound keys each generate different unique sounds when the keys are pressed and returned.

3. The key input device of claim 1, wherein the sound keys each further include a signal generator in which electrodes are brought in contact by key input, and the key input device further includes an input signal generator that creates a standard key input signal and transmits the signal through wire/wireless communication in accordance with operation of the signal generators of the sound keys.

4. The key input device of claim 1, wherein the unique sound is used as a factor by which at least one of a natural frequency, a unique pattern, and a unique sound feature is discriminated.

5. The key input device of claim 1, wherein the sound generator is an elastic unit for pressing and returning the key or an elastic member inducting electrode contact when the key is pressed and returned.

6. The key input device of claim 1, wherein the sound generators are different in physical shape for each key.

7. The key input device of claim 1, wherein the sound keys or the body has an opening for transmitting a sound to a terminal corresponding to the key input device.

8. A key input recognition device comprising:
a microphone that receives a sound;
a sound input processor that discriminates of predetermined unique sounds of sound keys from sounds received by the microphone, recognizes the kinds of the keys, and determines that input has been made through the keys; and
a controller that performs a process of processing the key input in accordance with the determination result by the sound input processor.

9. The key input recognition device of claim 8, wherein the sound input processor determines a key input state, a continuous input state according to an input-continued time, and a complex key input state according to simultaneous pressing of a plurality of keys, on the basis of unique sounds generated when the sound keys are pressed and returned.

10. The key input recognition device of claim 9, wherein the sound input processor recognizes a predetermined unique sound according to pressing of a sound key, and determines input as a result of key combination according to complex key input when the sound input processor determines that another sound key has been pressed before a unique sound according to returning of the key is recognized.

11. The key input recognition device of claim 8, wherein the sound input processor processes key input at a high speed on the basis of only the unique sound according to pressing of a sound key, in accordance with a mode or the kind of a key.

12. The key input recognition device of claim 8. further comprising a user interface receiving selection information by a user in cooperation with the controller,
wherein the sound input processor changes a determination way according to recognition of a unique sound of a sound key in accordance with selection information by a user provided through the user interface.

13. A key input system comprising:
a key input device that includes sound keys respectively generating different unique sounds when keys are pressed; and
a key input recognition device that receives sounds generated by the sound keys through a sound sensor when input is made through the key input device, discriminately recognizes the unique sounds of the sound keys from received sounds, and determines that input has been made through the keys and processes corresponding key input.
